(19) United States
(12) Patent Application Publication
(10) Pub. No.: US 2024/0064488 A1
(43) Pub. Date: Feb. 22, 2024

(54) MBSFN AREA INNER AND OUTER SAI FOR SEAMLESS MOBILITY

(71) Applicant: Telefonaktiebolaget LM Ericsson (publ), Stockholm (SE)

(72) Inventors: Joakim Åkesson, Landvetter (SE); Jinyang Xie, Shanghai (CN); Salvador Hinarejos FERNANDEZ, Madrid (ES)

(21) Appl. No.: 17/766,710

(22) PCT Filed: Oct. 9, 2020
(86) PCT No.: PCT/EP2020/078414

§ 371 Date: Apr. 5, 2022

(30) Foreign Application Priority Data
Oct. 9, 2019 (WO) PCT/CN2019/110132

(51) Int. Cl. H04W 4/021; H04W 4/08

(52) U.S. Cl. CPC H04W 4/021; H04W 4/08

(57) ABSTRACT

A wireless device (“UE”) that is operable to communicate with a network node of a group communication services (“GCS”) network can receive first data from the network node over a first type of GCS transmission based on a first location of the UE in a network coverage area. The UE can detect that the UE has moved to a second location. Responsive to detecting that the UE has moved to the second location, the UE can transmit a message to the network node based on the second location. Responsive to transmitting the message to the network node, the UE can receive second data over a second type of GCS transmission that is different than the first type of GCS transmission.

### TECHNICAL FIELD

The present disclosure relates generally to communication, and more particularly to operations in a group services communication (“GCS”) network and related nodes of the GCS network.

### BACKGROUND

A mission critical push-to-talk (“MCPTT”) service supports an enhanced push-to talk, (“PTT”) service, which is suitable for mission critical scenarios. A MCPTT service can support communications between several users (a group call), where each user has the ability to gain access to the permission to talk in an arbitrated manner. A MCPTT can provide a professional PTT service to public safety, transport companies, utilities, and industrial and nuclear plants. Based on the operational model, the performance and the MCPTT feature set vary per user organization, where some functionality that is more mission critical specific might not be available to commercial customers. A MCPTT user may monitor several groups where the traffic pattern is characterized by having long periods of silence; short MCPTT group calls (e.g., 20-30 seconds); few talk bursts in each call (e.g., 4-8 talk bursts); access time (e.g., setup time) of less than 300 ms; and/or mouth-to-ear latency of less than 300 ms.

The current public safety networks (TETRA and P25) are narrowband systems, which were originally designed to support voice and low bitrate data services. Those networks are not able to provide the necessary high-speed data performance to support the multimedia applications, on which current public safety agencies are increasingly relying. Those legacy networks are not able to provide the support for data intensive services, such as real time video streaming, file downloads, and web browsing. These services supplement the MCPTT service through providing improved situation awareness for both first responders and dispatchers.

Long term evolution (“LTE”) is established as a primary technology for the next generation of the broadband public safety network. The broadband communications provide high-rate data and low-latency video services, which enables new ways of working for emergency services. The market trend requests to transit the MCPTT for first responders from the current narrow band network technologies to LTE. The LTE network can further enable other mission critical services, such as mission critical video delivery and mission critical data delivery.

In the mobile transmission network, radio resources are limited, and depend on demand. Therefore, the end user Quality of Experience (“QoE”) cannot always be guaranteed. LTE broadcast, also known as Evolved Multimedia Broadcast/Multicast Service (“eMBMS”), provides a Point To Multipoint (“PTM”) delivery. PTM is offered by cellular networks that overcome the air limitations of unicast transmission, which is Point to Point (“PTP”). PTM enables content delivery in an efficient way in both RAN and the core network.

### SUMMARY

According to some embodiments, a method of operating a wireless device that is communicating with a network node of a group communication services, GCS, network is provided. The non-terrestrial communication path including satellites and satellite gateways. The method can include receiving first data from the network node over a first type of GCS transmission based on a first location of the UE in a network coverage area. The method can further include detecting that the UE has moved to a second location. The method can further include, responsive to detecting that the UE has moved to the second location, transmitting a message to the network node based on the second location. The method can further include, responsive to transmitting the message to the network node, receiving second data over a second type of GCS transmission that is different than the first type of GCS transmission.

According to some other embodiments, a method of operating a network node that is communicating with a wireless device, UE, of a group communication services, GCS, network is provided. The method can include transmitting first data to the UE over a first type of GCS transmission based on the UE being in a first location in the network coverage area. The method can include receiving a message from the UE. The method can include determining, based on the message, that the UE has moved to a second location in the network coverage area. The method can include, responsive to determining that the UE has moved to the second location in the network coverage area, transmitting second data to the UE over a second type of GCS transmission that is different than the first type of GCS transmission.

According to some other embodiments, a wireless device, UE, that is communicating with a network node of a group communication services, GCS, network. The UE can include a processor and memory coupled to the processor. The memory can have instructions stored therein that are executable by the processor for causing the processor to receive first data from the network node over a first type of GCS transmission based on a first location of the UE in a network coverage area. The instructions can be further executed to cause the processor to detect that the UE has moved to a second location. The instructions can be further executed to cause the processor to, responsive to detecting that the UE has moved to the second location, transmit a message to the network node based on the second location. The instructions can be further executed to cause the processor to, responsive to transmitting the message to the network node, receive second data over a second type of GCS transmission that is different than the first type of GCS transmission.

According to some other embodiments, a network node that is operable to communicate with a wireless device, UE, of a group communication services, GCS, network is provided. The network node can include a processor and memory coupled to the processor. The memory can have instructions stored therein that are executable by the processor for causing the processor to transmit first data to the UE over a first type of GCS transmission based on the UE being in a first location in the network coverage area. The instructions can be further executed to cause the processor to receive a message from the UE. The instructions can be further executed to cause the processor to determine, based on the message, that the UE has moved to a second location in the network coverage area. The instructions can be further executed to cause the processor to, responsive to determining that the UE has moved to the second location in the network coverage area, transmit second data to the UE over a second type of GCS transmission that is different than the first type of GCS transmission.

Various embodiments described herein can mitigate interruptions during switching between types of GCS transmissions due to UE mobility.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram of an example of MCPTT On-Network Architecture according to some embodiments of the present disclosure;

FIG. 2 is a schematic diagram illustrating an example of MBSFN Area reserved cells according to some embodiments of the present disclosure;

FIG. 3 is a schematic diagram illustrating an example of MBSFN area configuration with reserved cells or support cells according to some embodiments of the present disclosure;

FIG. 4 is a schematic diagram illustrating an example of MBSFN area with inner ring SAI and outer ring SAI configuration according to some embodiments of the present disclosure;

FIG. 5 is a schematic diagram illustrating an example of a wireless device, UE, moving from a broadcast area to a non-broadcast area according to some embodiments of the present disclosure;

FIG. 6 is a schematic diagram illustrating an example of a wireless device, UE, moving from a non-broadcast area to a broadcast area according to some embodiments of the present disclosure;

FIGS. 7A-B are signal flow diagrams illustrating an example of a transition from broadcast to unicast delivery according to some embodiments of the present disclosure;

FIGS. 8A-B are signal flow diagrams illustrating an example of a transition from unicast to broadcast delivery according to some embodiments of the present disclosure;

FIGS. 9A-B are signal flow diagrams illustrating another example of a transition from unicast to broadcast delivery according to some embodiments of the present disclosure;

FIG. 10 is a signal flow diagram illustrating an example of a media delivery procedure according to some embodiments of the present disclosure;

FIGS. 11A-B are schematic diagrams illustrating an example of a MBSFN area with inner ring and outer ring according to some embodiments of the present disclosure;

FIG. 12 is a schematic diagram illustrating an example of a MBSFN area according to some embodiments of the present disclosure;

FIG. 13 is a signal flow diagram illustrating an example of switching from unicast delivery to MBMS delivery based on the UE detecting it is in an inner SAI according to some embodiments of the present disclosure;

FIG. 14 is a signal flow diagram illustrating an example of switching from MBMS delivery to unicast delivery based on the UE detecting it is in an outer SAI according to some embodiments of the present disclosure;

FIG. 15 is a signal flow diagram illustrating an example of switching from unicast delivery to MBMS delivery based on the UE location changing according to some embodiments of the present disclosure;

FIG. 16 is a signal flow diagram illustrating an example of switching from MBMS delivery to unicast delivery based on the UE location changing according to some embodiments of the present disclosure;

FIG. 17 is a block diagram illustrating an example of a wireless device (“UE”) according to some embodiments of the present disclosure;

FIG. 18 is a block diagram illustrating an example of a radio access network (“RAM”) node (e.g., a base station eNB/gNB) according to some embodiments of the present disclosure;

FIG. 19 is a block diagram illustrating an example of a core network (“ON”) node (e.g., an AMF node, an SMF node, an OAM node, etc.) according to some embodiments of the present disclosure;

FIGS. 20-21 are flow charts illustrating examples of processes for switching between types of GCS transmissions based according to some embodiments of the present disclosure;

FIG. 22 is a table illustrating an example of a MBMS listening status report according to some embodiments of the present disclosure;

FIG. 23 is a table illustrating an example of a MBMS bearer announcement according to some embodiments of the present disclosure;

FIGS. 24-26 are portions of programs illustrating examples of code for switching between types of GCS transmissions based according to some embodiments of the present disclosure;

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

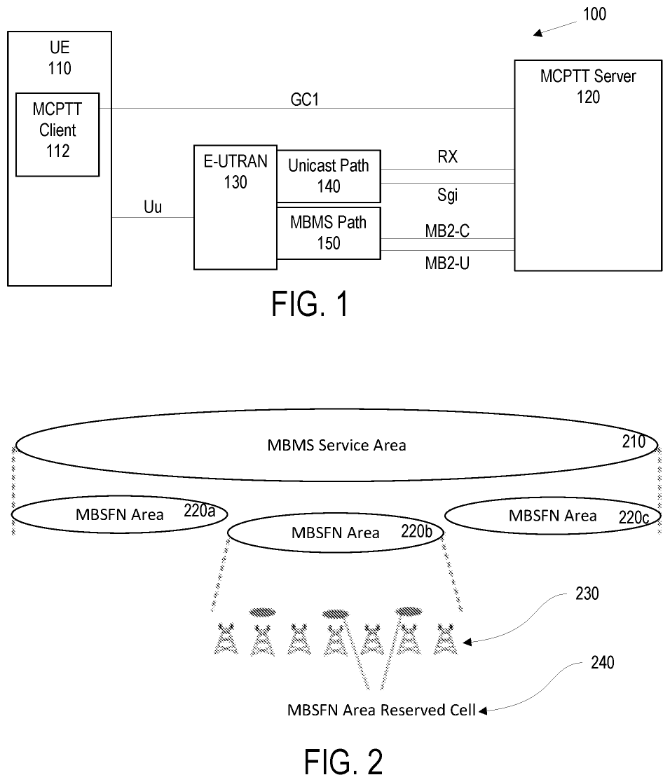

### FIG. 1

FIG. 1 illustrates an example of a mission critical push-to-talk (“MCPTT”) On-Network Architecture 100. The MCPTT On-Network Architecture includes a UE 110 with a MCPTT client 112 and a MCPTT server 120. The UE 110 can be communicatively coupled to the MCPTT server 120 by a first group communication connection. The UE 110 can also be communicatively coupled to the MCPTT server 120 via an E-UTRAN 130. The UE 110 can be communicatively coupled to the E-UTRAN 130 and the E-UTRAN 130 can communicate with the MCPTT server 120 via a unicast path 140 or an MBMS path 150.

Long term evolution (“LTE”) broadcast enables synchronized transmission between multiple transmitters in the form of Multicast-Broadcast Single Frequency Network (“MBSFN”) operation. In this way, identical signals can be broadcast by multiple transmitters synchronously, inter-cell interference can be avoided, and the Signal-to-Interference Ratio (“SIR”) can be dramatically increased.

A group communication services (“GCS”) application server (“AS”) can use evolved packet system (“EPS”) bearer services and may use multimedia broadcast multicast service (“MBMS”) bearer services for transferring application signaling and data between the GCS AS and wireless devices (“UEs”). In an uplink direction, a UE can use an EPS bearer service to exchange application signaling with the GCS AS or when it wants to send data to the GCS AS. In a downlink direction the GCS AS may transfer application signaling and data via the UE, individual EPS bearer services, and/or via MBMS bearer service. When a GCS UE moves between areas where its MBMS broadcast bearers are available or not, the UE can inform the GCS AS via application signaling that it changes from MBMS broadcast bearer reception to non-reception, or vice versa, the GCS AS can activates or deactivates the downlink application signaling and data transfer via the UE individual EPS bearer(s) as appropriate. To accomplish service continuity, a UE may temporarily receive the same GCS application signaling and data in parallel via EPS bearer(s) and MBMS service(s). The GCS UE application can discard any received application signaling or data duplicates.

MCPTT is just one of the Mission Critical Service, the MCPTT On-network Architecture could be fit for the MC Data, MC video, and other group communication service as well. The embodiments described herein can be applied to any MC service or group communication service, and is not limited to MCPTT.

A MBMS single-frequency network (“MBSFN”) area can include a group of cells within an MBSFN Synchronization Area of a network, which are coordinated to achieve an MBSFN Transmission. Interference problems can be mitigated by configuring some selected cells in a ring just outside the MBSFN area to be silent on subframes that are used for broadcast by the MBSFN area cells. These cells can be called “Reserved Cells.” Except for the MBSFN area reserved cells, all cells within an MBSFN Area may contribute to the MBSFN Transmission and advertise its availability.

### FIG. 2

FIG. 2 illustrates an example of a MBSFN area 220b with a reserved cell 240. FIG. 2 further illustrates that the MBSFN area 220b along with other MBSFN areas 220a, 220c are part of MBMS service area 210. A further enhancement of the interference protection may include allowing the reserved cells to join the eMBMS broadcast. Reserved cells that are part of the eMBMS broadcast can be referred to as “supporting cells.” The effect can be achieved by extending the MBSFN area with the supporting cells without changing the definition of the geographical service area.

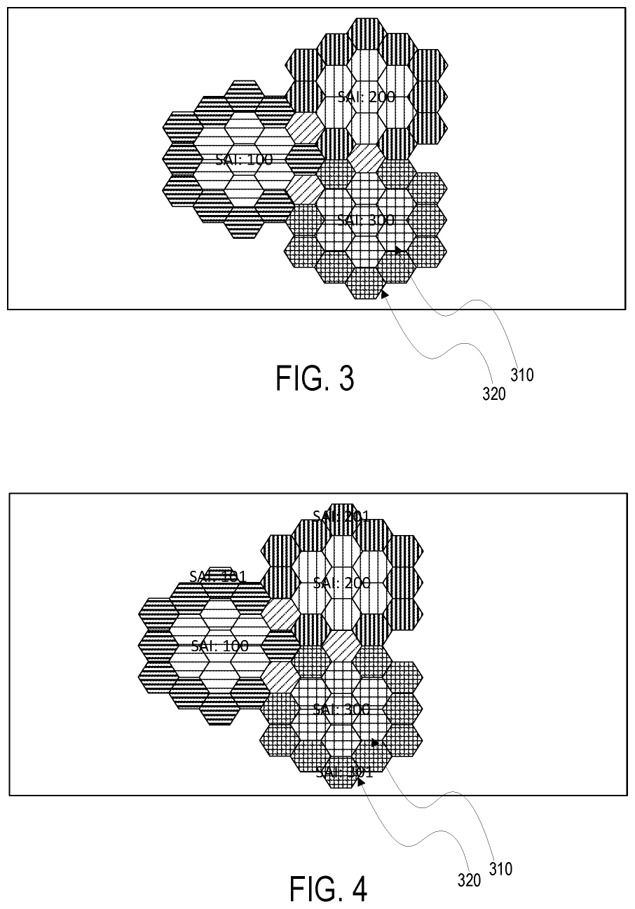

### FIG. 3

FIG. 3 illustrates an example of three MBSFN areas configured with reserved cells. The three MBSFN areas each include inner area cells 310 and outer area cells 320. The reserved cells are in part of the outer cells 320 and some of the reserved cells of different MBSFN areas overlap. The three MBSFN areas each have a service area identifier (“SAI”) 100, 200, 300.

Problems can arise from trying to secure the service continuity during the switching from Unicast Delivery to MBMS Delivery and vice-versa. When a UE moves into the MBSFN broadcast coverage, the UE can simultaneously receive data by Unicast Delivery and MBMS Delivery. However, it can be unclear what conditions will trigger the UE to notify the GCS AS via GC1 that it is in MBMS coverage and notify MCPTT AS to stop the unicast delivery for the network resource efficiency. Similarly, when a UE is about to move out of the MBSFN broadcast coverage, it unclear how the UE should know it is about to move out of the MBSFN broadcast cover, and when it should notify the GCS AS to set up the unicast delivery before it is out of coverage.

According to 3GPP TS 23.468, there are 2 different two procedures for service continuity for switching from MBMS Delivery to Unicast Delivery: MBMS Delivery to Unicast Delivery (referred to as make-before-break); and MBMS Delivery to Unicast Delivery (referred to as break-before-make). In the make-before-break (“MBB”) process, the UE can detect that it is about to move out of MBMS coverage and elect to receive data over unicast while still within MBMS coverage. The MBB process can achieve service continuously such that there is no service interruption. In the break-before-make (“BBM”) process, the UE can detect that it has moved out of MBMS coverage and elect to receive data over unicast. In the BBM process, the UE can start receiving downlink (“DL”) data over unicast after it has stopped receiving data over MBMS, which may cause some service interruption.

According to the current MBSFN area definition, regardless of the reserved cells or supporting cells, they have the same SAI as the participating cells. When the UE's MiddelWare (“MW”) retrieves the location where the UE is camping, it will get the same SAI in spite of it's locating in the MBSFN area inner ring or it is about to move out of the MBSFN area. As the UE does not know whether it is located in the edge of the MBSFN area, the UE has to measure the MBSFN signal quality periodically to check whether it is about to move out of the broadcast coverage. When the UE detects the MBSFN signal level is weak, for example the MBSFN signal level is smaller than one threshold, the UE knows it is about to move out of MBMS coverage. As the measurement is periodic, it requires some time to address the UE is about to move out of MBMS coverage (for example, the number of times of MBSFN signal level less than the min-threshold exceeds 3 times). And in a worse case, the UE may detect it is out of MBSFN broadcast coverage after it is unable to receive any data by MBMS Delivery for the corresponding MBMS bearer service, which can result in a service interruption.

In some embodiments, an MBSFN area can be defined as having inner cells in one SAI and outer cells in another SAI with a module named controller or manual configuration. The SAI in the MBSFN area(s) can be identified as inner type or an outer type and populated to GCS-AS or BM-SC.

In some embodiments, the UE can determine whether it is in an inner cell or an outer cell. The MW or UE Application can be aware of the SAIs with properties as Inner type or Outer type. The MW or UE Application can be aware that the camping cell is in the MBSFN area inner ring or the MBSFN area outer ring. The MW or UE Application can notify the GCS AS via GC1 that it is camping in an outer cell and that the UE may move out of MBMS coverage and the GCS AS can set up a unicast flow. The MW or UE Application can request the unicast directly when it detects the location is camping in the outer SAI.

In some embodiments, the GCS AS can determine whether the UE is in an inner cell or an outer cell. The MW or UE Application can report the location information to the GCS AS. The MW or UE Application can report the reception status (including SAI or signal QoS or both) to the GCS AS. The GCS AS decide to setup/shutdown the unicast flow based on the reception status report.

Various embodiments that introduce the different SAIs for the MBSFN area inner ring cells (participating cells) and MBSFN area outer ring cells (supporting cells) provide advantages. The Application Server (MCPTT AS or BM-SC) and UE can understand the MBSFN Area Inner ring SAI and MBSFN Outer ring SAI (MBSFN area border) and it can be flexible for UE to detect the UE's camping area is in MBSFN area center or MBSFN border except for the MBSFN signal level, and then to achieve the seamless switching between the Unicast and Broadcast delivery. Some embodiments, achieve the good quality in the MBMS area border through both unicast and broadcast delivery for the GCS and it can be flexible for GCS AS or BM-SC to setup or stop the unicast delivery with camping SAI, which can improve network resource efficiency and avoid the round-trip switching.

During the MBSFN area configuration, an operator can configure the different SAIs for the MBSFN area inner ring cells and MBSFN area outer ring cells using the controller module or manual configuration.

### FIG. 4

FIG. 4 depicts three MBSFN areas each with an inner cells 310 and an outer cells 320. The inner cells 310 have an inner SAI 100, 200, 300 and the outer cells 320 have an outer SAI 101, 201, 301. MBSFN area inner ring SAI and outer ring SAI information can be transferred to BM-SC or the AS for the service announcement and discovery. The service announcement and discovery from BM-SC or GCS AS can include the inner SAI or outer SAI.

In some embodiments, the UE can receive the service announcement fragments from the GCS AS. When the UE location is changed, the UE can retrieve the UE location, and the UE can send the new location in the location information report or MBMS listening status report to the GCS AS. When the GCS AS receive the location information report or MBMS listening status report, it can check MBMS listening status and the location with the SAI information in the GCS AS.

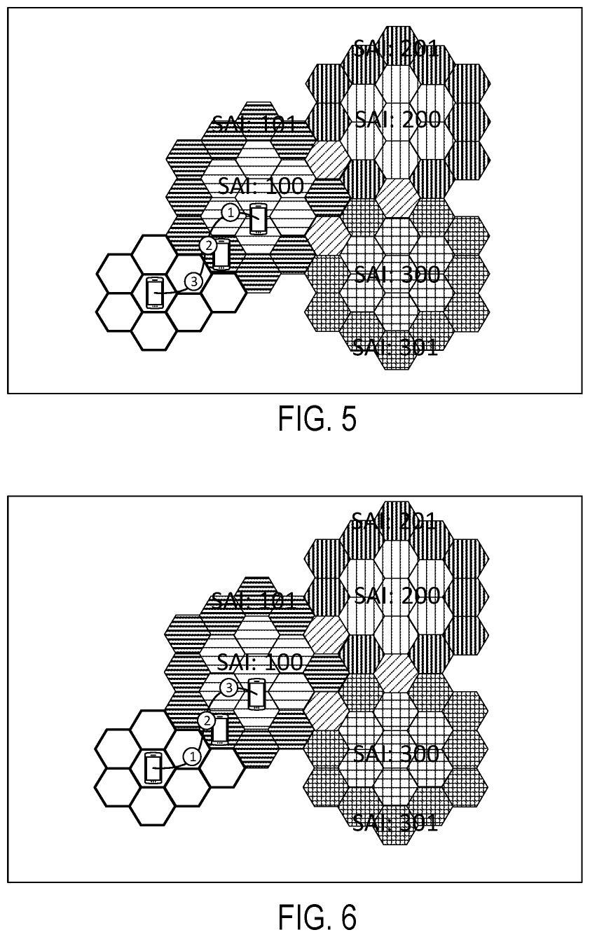

### FIG. 5

FIG. 5 illustrates an example of a UE moving from a location in a broadcast area to a location outside of the broadcast area.

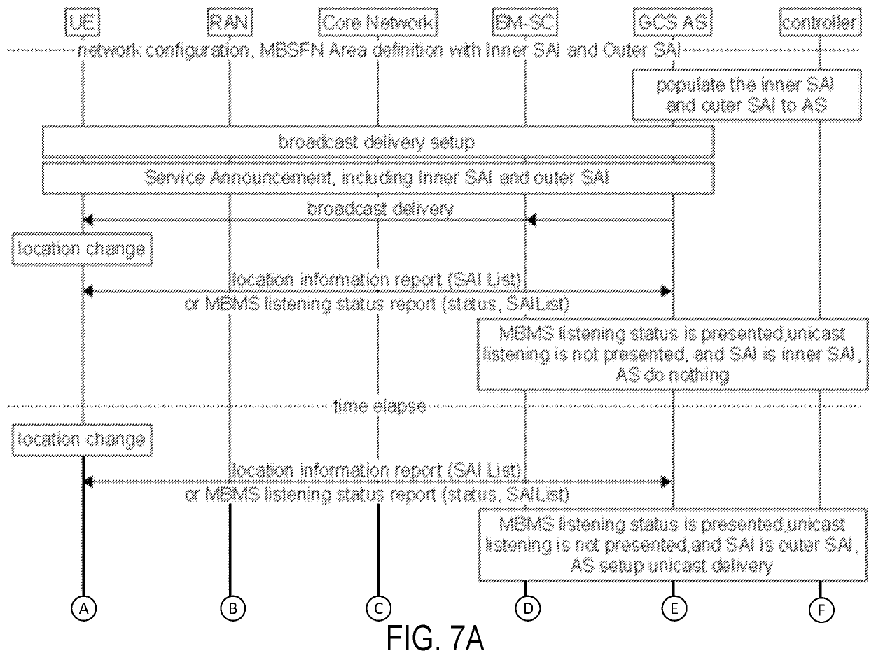

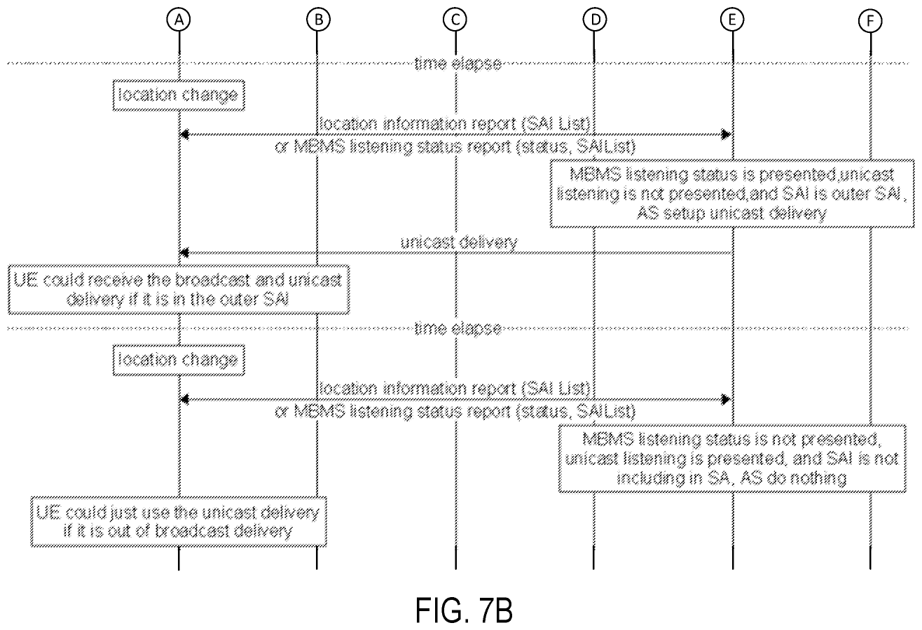

### FIG. 7A-B

FIGS. 7A-B are a flow chart illustrating an example of process performed as the UE moves from the broadcast area to the non-broadcast area. At location 1 in FIG. 5, the UE is in the broadcast area and receiving the contents through the broadcast bearer. When the UE is in the mobility status, the UE can send the location information report and/or MBMS reception status report during the location change. When the GCS AS receives the location information report or MBMS listening status report, the GCS AS can check the MBMS listening status and location information. If the MBMS listening status is presented and the unicast listening status is not presented, and the SAI in the location information is the inner SAI, the GCS AS can assume the MBSFN signal level is strong enough. The GCS AS may not take further actions, and UE can continue receive the content from broadcast delivery. If the UE moves to location 2 in FIG. 5, the MBMS listening status can be present and the SAI in the location information can be the outer SAI. The GCS AS can detect the UE is in the edge of the MBMS broadcast area and assume that the UE may move out of MBMS coverage. Therefore, the GCS AS can set up a unicast flow, which can allow the UE to receive content both from unicast and broadcast delivery. If the UE has moved out of the broadcast coverage, for example to location 3, the UE can just receive content from the unicast delivery. The location information report or MBMS listening status report may not include the SAI information.

### FIG. 6

FIG. 6 illustrates an example a UE moving from a location outside a broadcast area to a location inside the broadcast area.

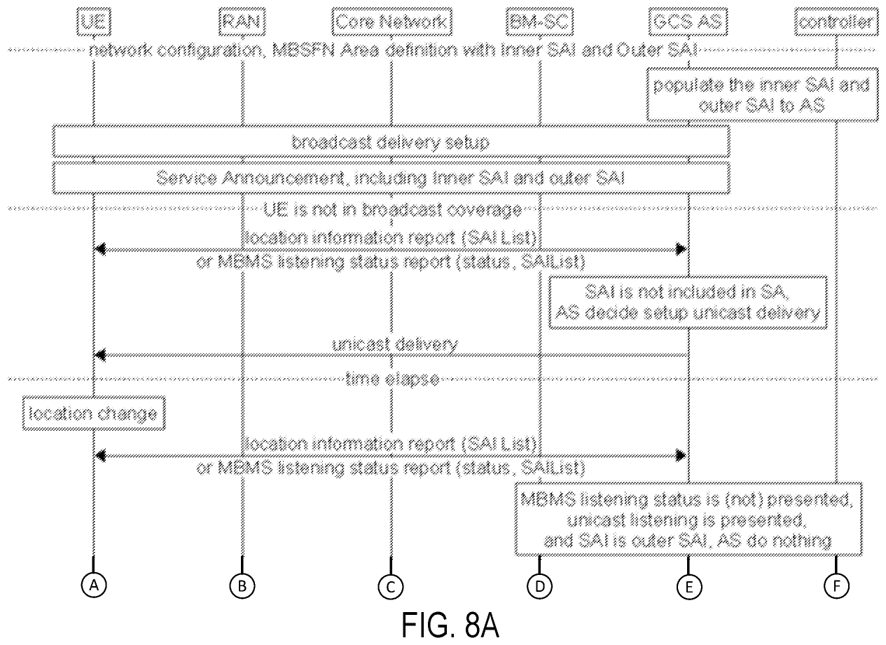

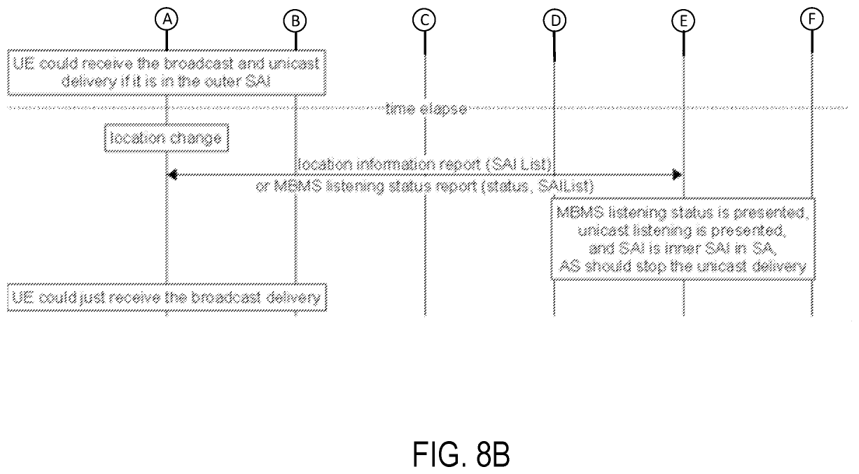

### FIG. 8A-B

FIGS. 8A-B are a flow chart illustrating an example of process performed as the UE moves from the broadcast area to the non-broadcast area. If the UE moves from the non-broadcast coverage to the broadcast coverage, the UE may send the location information report or MBMS listening status report to the GCS AS. When the GCS AS receives the location information report or MBMS listening status report, it can check the MBMS listening status and location information. If the MBMS listening status is not presented (no MBMS listening previous), the unicast listening status is presented (the previous receiving was the unicast receiving), and the SAI in the location information is not attributed to this service, as when the UE is in location 1 in FIG. 6, GCS AS may not do any further actions, and the UE can continue to receive the content from unicast delivery. If the MBMS listening status is not presented (no MBMS listening previous) and the unicast listening status is presented, and the SAI in the location information is the outer SAI, as when the UE is in location 2 in FIG. 6, GSC AS will not do any further actions, but it may receive the content both from the unicast and broadcast. If both MBMS listening status and the unicast listening status is presented, and the SAI is the inner SAI, as when the UE is in location 3 in FIG. 6, GCS AS can stop sending the data over by Unicast Delivery to this UE such that the UE only receives the content by MBMS broadcast delivery.

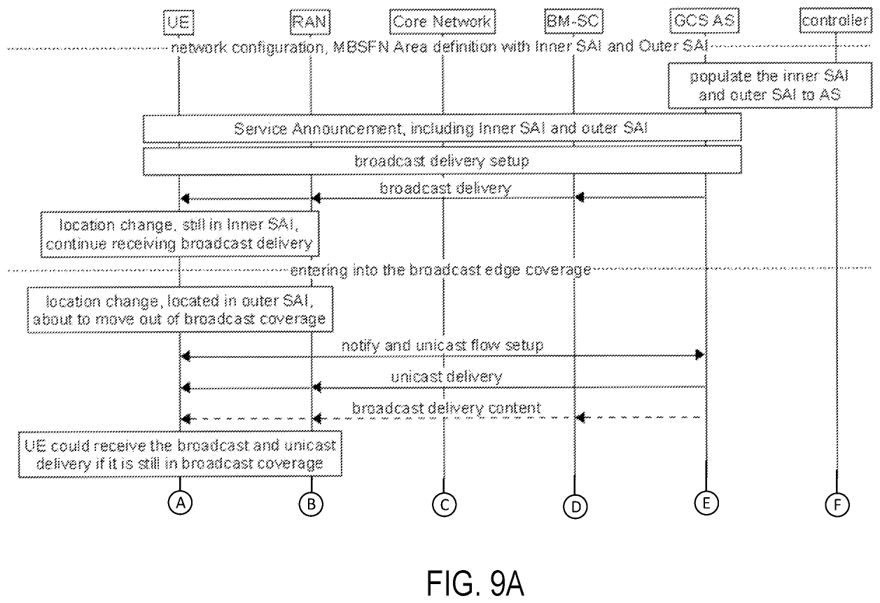

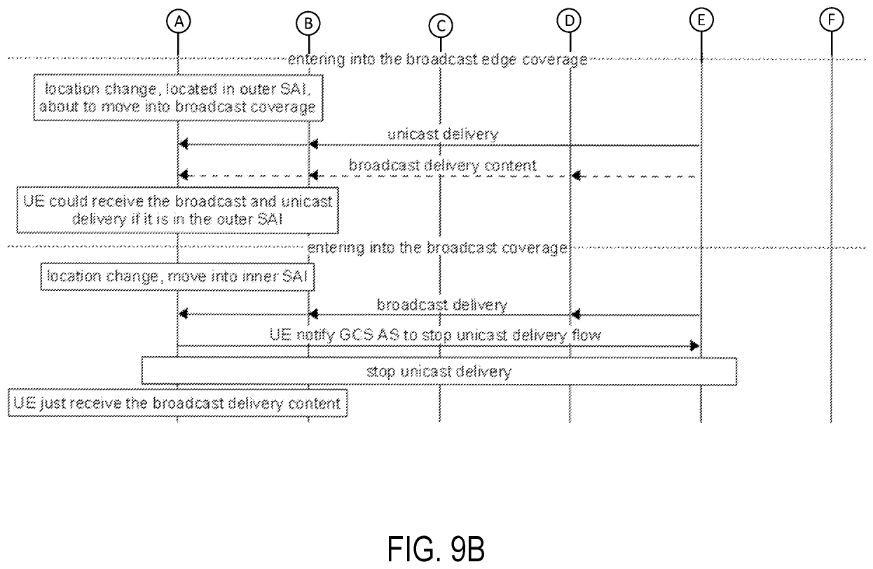

### FIG. 9A-B

FIGS. 9A-B illustrate a flow chart for a UE determining whether it is in an inner are or outer area of a MBSFN area and requesting adjustments in the type of GCS communication it receives. The UE can receive the service announcement fragments including the inner SAI or outer SAI from the GCS AS. When the UE location is changed, the UE can retrieve the UE location, the UE can compare the SAI in the UE location with the inner SAI or outer SAI in the Service Announcement fragments. If the location is the inner SAI, and the MBSFN signal level is strong enough, the UE Application may not take further actions and can continue receiving the content from broadcast delivery. If the UE location is in an outer SAI, the UE can notify the GCS AS that it is in the outer SAI and that it may move out of MBMS coverage. The GCS AS can set up a unicast flow such that the UE can receive the content both from unicast and broadcast delivery. If the UE moves out of the broadcast coverage, the UE can just receive the contents from the unicast delivery. If the UE moves from the non-broadcast coverage to the broadcast coverage and the UE location is the outer SAI location, the UE can begin receiving the content both from the unicast and broadcast. When the UE detects it moves into the inner SAI location, the UE can notify the GCS AS that it is in MBMS inner SAI coverage and receiving the MBMS broadcast delivery. The GCS AS can stops sending the data to the UE by Unicast Delivery and the UE may receive the content only by MBMS broadcast delivery.

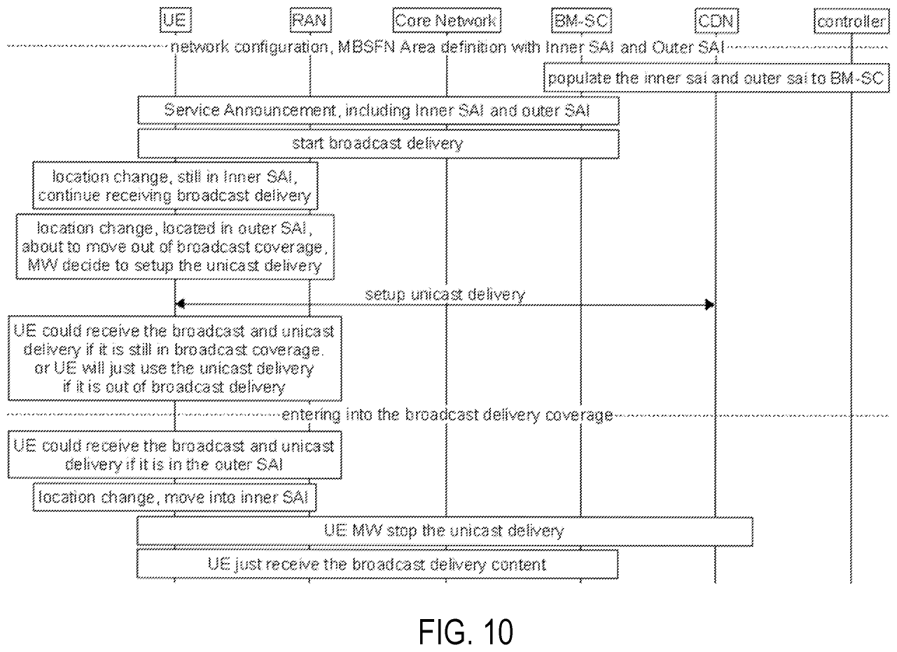

### FIG. 10

FIG. 10 illustrates an example of a media delivery procedure. UE MW (e.g., rather than the UE Application) can receive the service announcement fragments from the BM-SC. When the UE location is changed, the UE MW can get the UE camping SAI list. The UE MW can compare the SAI in the UE location with the inner SAI or outer SAI in the MBSFN area of the Service Announcement fragments. If the location is the inner SAI and the MBSFN signal level is strong enough, the UE MM may not take any further actions and can continue to receive content from broadcast delivery. If the location is the outer SAI, the UE MW can setup (or request setup of) the unicast delivery using the unicast delivery method in the service announcement fragment since the UE may move out of MBMS coverage. At this stage, UE MW can receive the content both from unicast and broadcast delivery. And then, if the UE has moved out of the broadcast coverage, the UE MW will just receive the contents from the unicast delivery. If the UE moves from the non-broadcast coverage to the broadcast coverage and the location is the outer SAI location, the UE MW can receive the content both from the unicast and broadcast. When the UE MW detects it moves into the inner SAI location, the UE can stop the unicast delivery and receive the content from broadcast delivery only.

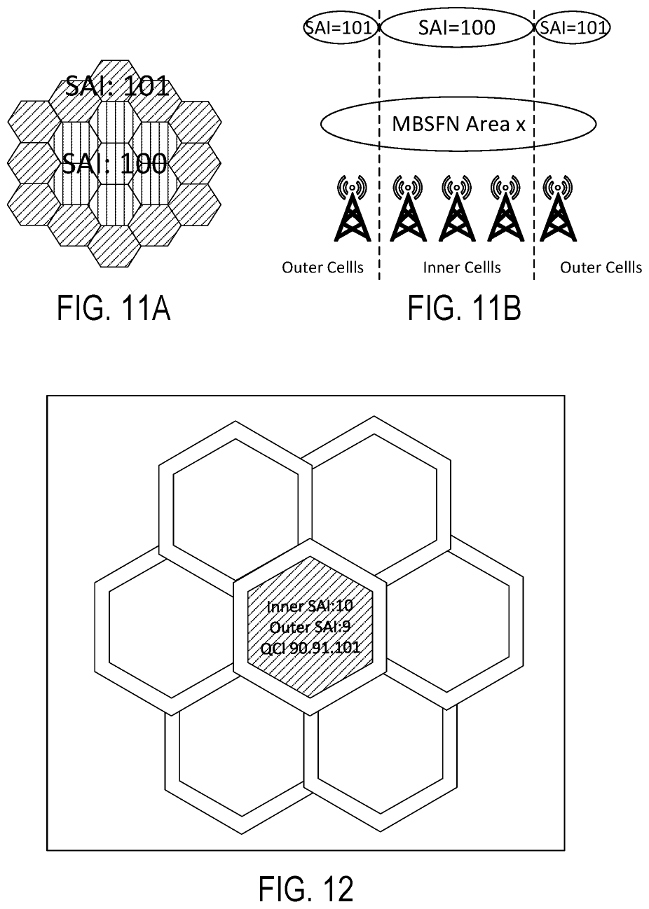

### FIG. 11A-B

FIGS. 11A-11B illustrate that a MBSFN area can be configured with a defined inner ring and outer ring and assign different SAIs for cells in the inner ring cells and outer ring. The cells in the area inner ring will be assigned SAI 100, the cells in the outer ring will be assigned SAI 101. An operator can create the MBSFN areas in the RAN through a controller module or manual configuration in the RAN. The controller module can create the MBSFN area inner ring and outer ring and assign the different SAIs to the cells in inner ring and outer ring.

### FIG. 12

FIG. 12 illustrates an example with multiple MBSFN areas with an inner ring and an outer ring generated by the controller module. After the MBSFN areas definition is complete, the MBSFN area can be configured to the RAN. The MBSFN area's inner SAI and outer SAI information can be populated to the BM-SC and the Application Server.

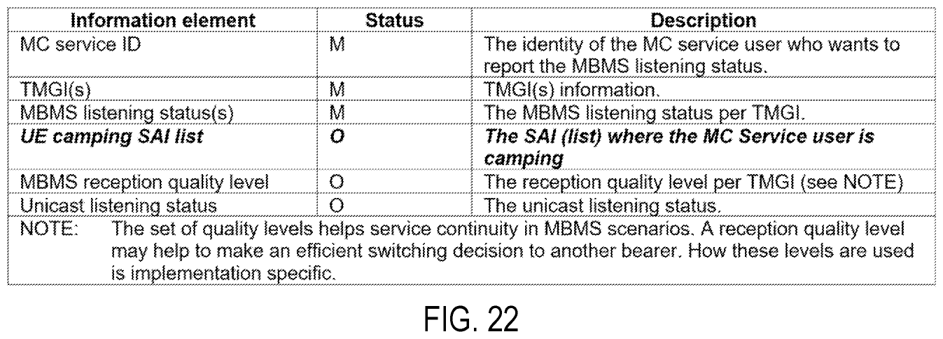

A MBMS listening status report is defined in TS 23.280 V16.2.0. In some embodiments described herein, the UE application can report a camping SAI list in the MBMS listening status report. FIG. 22 illustrates an example of the MBMS listening status report as defined in TS 23.280 V16.20 updated (indicated in bold/italics) to include the camping SAI list. FIG. 22 also describes information flow for the MBMS listening status report from MC service client to MC service server. The information is used for the decision on the switching from MBMS bearer to unicast bearer or vice versa. A MC service server can decide to switch from MBMS bearer to unicast bearer or vice versa based on the UE camping SAI in the location information report or based on the UE camping SAI and/or MBMS reception quality level which included in the MBMS listening status report. The set of quality levels can help service continuity in MBMS scenarios. A reception quality level may help to make an efficient switching decision to another bearer. How these levels are used is implementation specific.

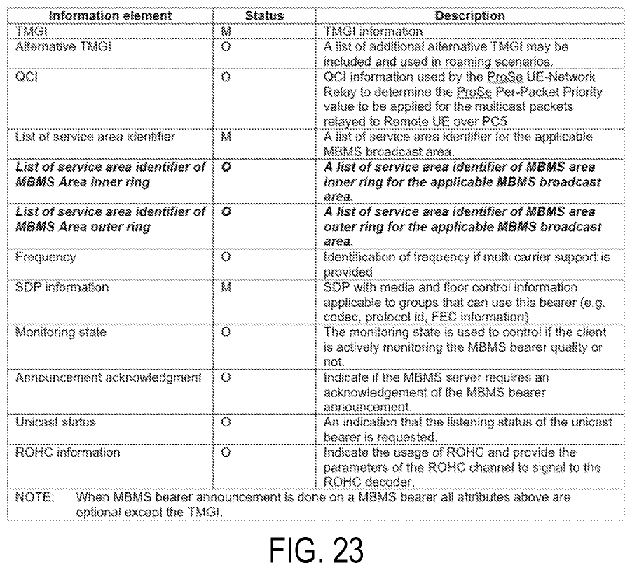

### FIG. 23

FIG. 23 is a table based on TS 23.280 V16.2.0 illustrating examples of updates to the MBMS bearer announcement for the MBMS area inner SAI and outer SAI in bold/italics.

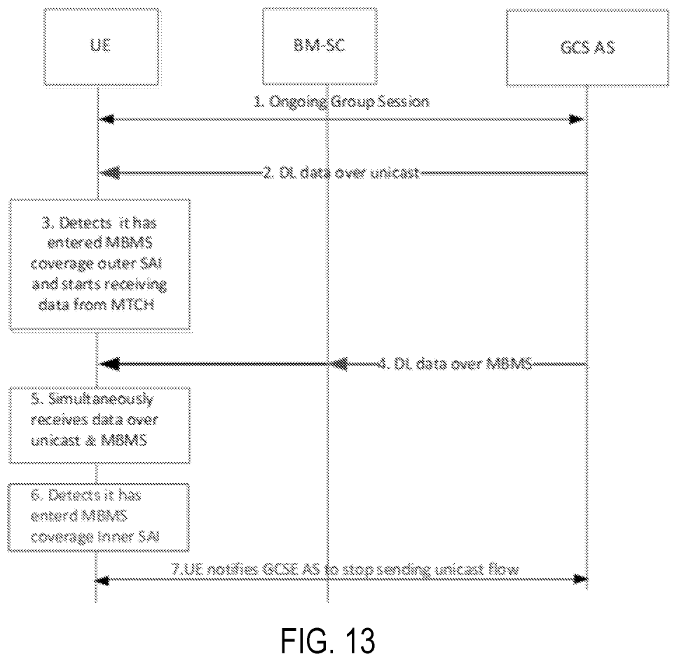

### FIG. 13

FIG. 13 illustrates an example of a process for service continuity when a UE which is receiving DL data over unicast moves into MBMS coverage. During the switching process, the UE simultaneously receives data from both unicast and MBMS, so there is no service interruption. At operation 1, the UE has an on going group communication and the GCS AS informs the UE, over GC1, of the availability of MBMS delivery in inner SAI and outer SAI and of the corresponding TMGI of the MBMS bearer service. At operation 2, the UE is receiving downlink data by Unicast Delivery. At operation 3, the UE detects it has entered MBMS coverage outer SAI and starts receiving MBMS Scheduling Information over MCH and the data from the MBMS bearer corresponding to the TMGI over MTCH. At operation 4, the UE receives DL data by MBMS Delivery. At operation 5, the UE simultaneously receives data by Unicast Delivery and MBMS Delivery. At operation 6, the UE detects it has entered MBMS coverage inner SAI. At operation 7, the UE notifies the GCS AS via GC1 that it is in MBMS coverage and receiving the MBMS bearer service corresponding to the TMGI. The GCS AS stops sending the data over by Unicast Delivery to this UE. The UE now receives the content only by MBMS Delivery.

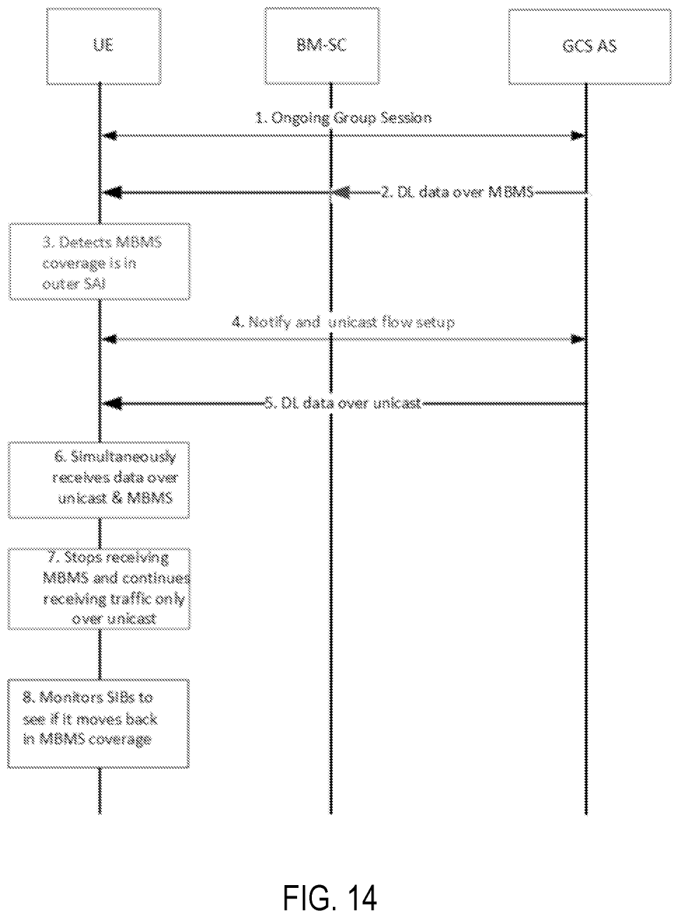

### FIG. 14

FIG. 14 illustrates an example of a process for service continuity when a UE is about to move to MBMS outer SAI and out of MBMS coverage. In this process, the UE detects that it has moved to MBMS outer SAI and elects to receive data over unicast while still within MBMS coverage. During the switching process, the UE simultaneously receives data from both unicast and MBMS, so there is no service interruption. At operation 1, the UE has an ongoing group communication. At operation 2, the UE is receiving downlink data by MBMS Delivery. At operation 3, the UE detects that it moves to MBMS outer SAI coverage, for the corresponding MBMS bearer service, through implementation-specific methods. At operation 4, the UE notifies the GCS AS that it moved to MBMS outer SAI and may move out of MBMS coverage via GC1 and the GCS AS sets up a unicast flow. At operation 5, the GCS AS now sends the downlink data by Unicast Delivery to this UE. At operation 6, the UE simultaneously receives DL data by Unicast Delivery and by MBMS Delivery. At operation 7, the UE ceases to receive the downlink data by MBMS Delivery but continues receiving data by Unicast Delivery. At operation 8, the UE monitors the SIBs in order to detect the TMGI on MCCH and thus determine it is back in MBMS coverage for the MBMS bearer service.

### FIG. 15

FIG. 15 illustrates an example of a process for service continuity when a UE which is receiving DL data over unicast moves into MBMS coverage. During the switching process, the UE simultaneously receives data from both unicast and MBMS, so there is no service interruption. At operation 1, the UE has an on going group communication and the GCS AS informs the UE, over GC1, of the availability of MBMS delivery in inner SAI and outer SAI and of the corresponding TMGI of the MBMS bearer service. At operation 2, the UE is receiving downlink data by Unicast Delivery. At operation 3, the UE detects it has entered MBMS coverage outer SAI and starts receiving MBMS Scheduling Information over MCH and the data from the MBMS bearer corresponding to the TMGI over MTCH. At operation 4, the UE receives DL data by MBMS Delivery. At operation 5, the UE simultaneously receives data by Unicast Delivery and MBMS Delivery. At operation 6, the UE detects the location change. At operation 7, the UE notifies the GCS AS via GC1 that the location information is changed or the MBMS listening status is changed. At operation 8, the AS detects the location is the inner SAI of this service, it decides to stop the unicast delivery.

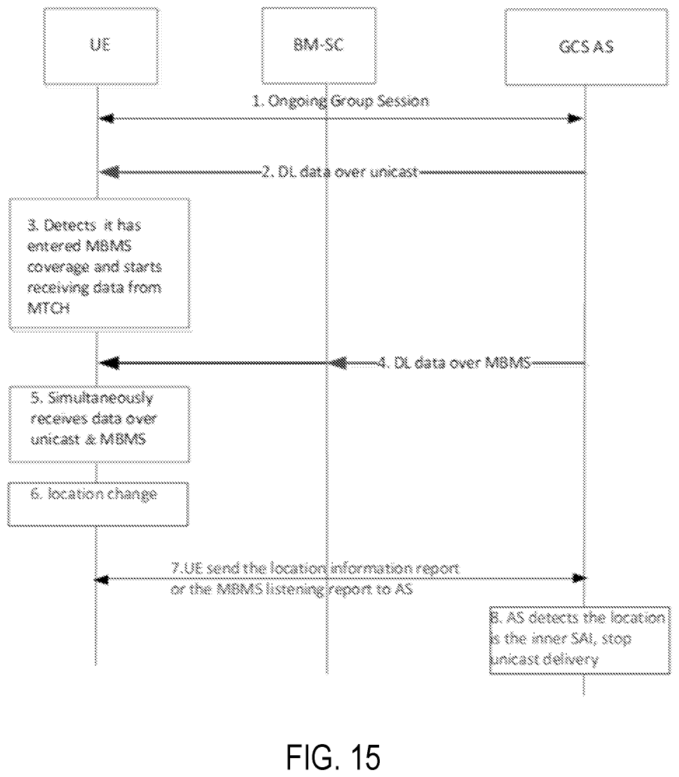

FIG. 16 FIG. 16 illustrates an example of a process for service continuity when a UE is about to move to MBMS outer SAI and out of MBMS coverage. In this process, the UE detects that moves to MBMS outer SAI and elects to receive data over unicast while still within MBMS coverage. During the switching process, the UE simultaneously receives data from both unicast and MBMS, so there is no service interruption. At operation 1, the UE has an ongoing group communication. At operation 2, the UE is receiving downlink data by MBMS Delivery. At operation 3, the UE detects the UE location is changed. At operation 4, the UE notifies the GCS AS that it moved to MBMS another SAI via GC1. At operation 5, the GCS AS detect the location is the MBMS outer SAI and sets up a unicast flow. At operation 6, the GCS AS now sends the downlink data by Unicast Delivery to this UE. At operation 7, the UE simultaneously receives DL data by Unicast Delivery and by MBMS Delivery. At operation 8, the UE ceases to receive the downlink data by MBMS Delivery but continues receiving data by Unicast Delivery. At operation 9, the UE monitors the SIBs in order to detect the TMGI on MCCH and thus determine it is back in MBMS coverage for the MBMS bearer service.

### FIGS. 22-26

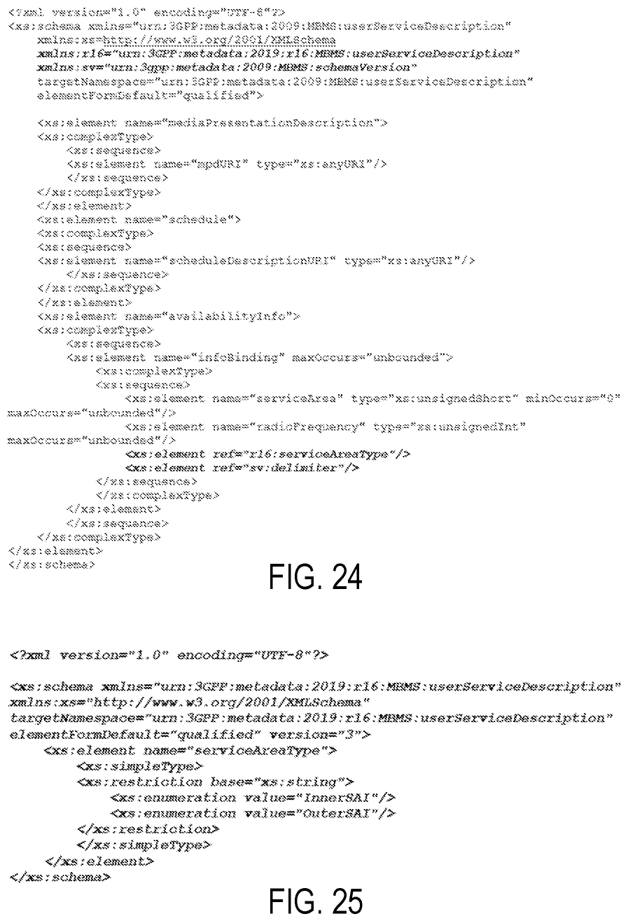

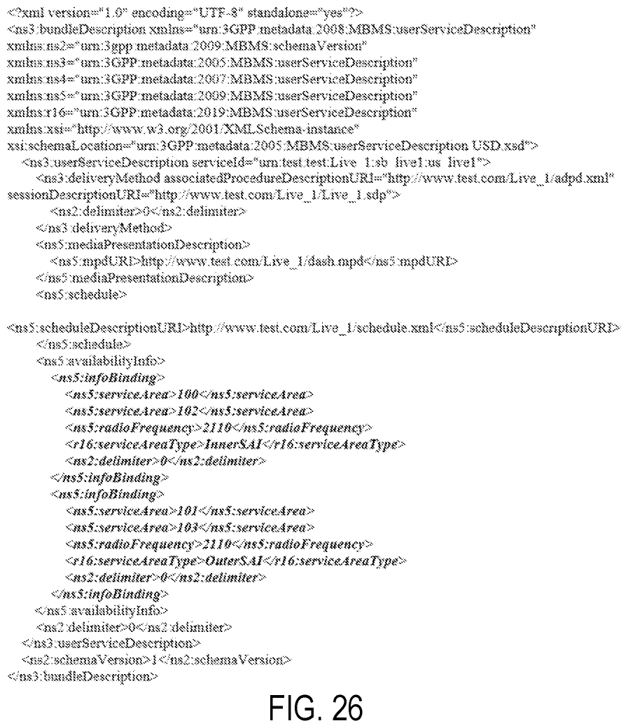

FIGS. 24-26 illustrates a portion of code based on TS 26.346 V16.1.0 (2019 March) for media service updated (in bold/italics) according to some embodiments. In order to make the UE MW be aware the inner SAI and outer SAI, service announcement fragment may be updated to include the inner SAI and outer SAI property. If the UE or MW detects the camping location is in the inner ring SAI list, the UE or MW could assume the MBSFN signal quality is good enough for the service delivery. If the UE or MW detects the camping location is in the outer ring SAI list, the UE or MW could be aware the UE is about to move out of the broadcast area or move in broadcast area. The UE or MW should establish the unicast delivery or keep the unicast delivery due to the UE is located in the MBSFN edge area. FIG. 24 illustrates changes to the code to support inner ring SAI and outer ring SAI. FIG. 25 illustrates Release 16 extension to the User Service Bundle Description Schema. FIG. 26 illustrates an example of the service announcement with service area type.

Various embodiments herein describe a process for a UE, MW, or GSC AS to detect the MBMS coverage through the MBSFN Area inner SAI and outer SAI. Some embodiments make the UE, MW, or GSC AS more robust to be able to decide the switching from Unicast Delivery to MBMS Delivery or the switching from MBMS Delivery to Unicast Delivery. Some embodiments achieve service continuity without service interruption.

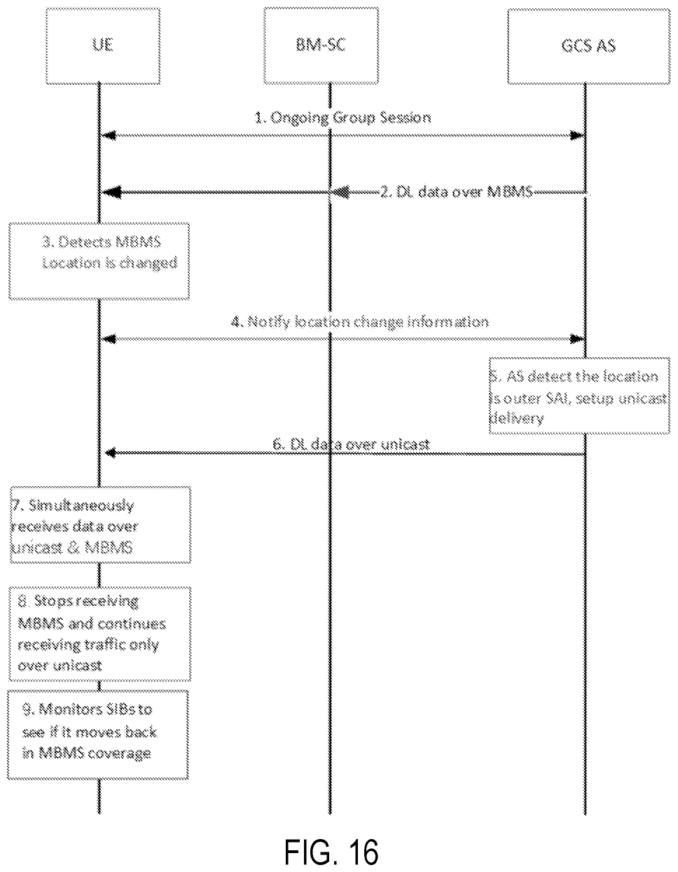

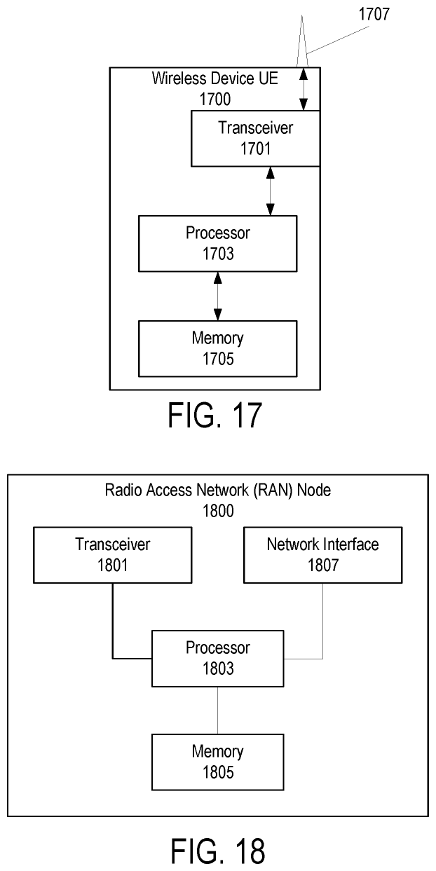

### FIG. 17

FIG. 17 is a block diagram illustrating elements of a wireless device UE 1700 (also referred to as a mobile terminal, a mobile communication terminal, a wireless communication device, a wireless terminal, a wireless communication terminal, user equipment, UE, a user equipment node/terminal/device, etc.) configured to provide wireless communication according to embodiments of inventive concepts. (Wireless device 1700 may be provided, for example, as discussed below with respect to wireless device QQ110 of FIG. 27.) As shown, wireless device UE may include an antenna 1707 (e.g., corresponding to antenna QQ111 of FIG. 27), and transceiver circuitry 601 (also referred to as a transceiver, e.g., corresponding to interface QQ114 of FIG. 27) including a transmitter and a receiver configured to provide uplink and downlink radio communications with a base station(s) (e.g., corresponding to network node QQ160 of FIG. 27) of a radio access network. Wireless device UE may also include processing circuitry 1703 (also referred to as a processor, e.g., corresponding to processing circuitry QQ120 of FIG. 27) coupled to the transceiver circuitry, and memory circuitry 1705 (also referred to as memory, e.g., corresponding to device readable medium QQ130 of FIG. 27) coupled to the processing circuitry. The memory circuitry 1705 may include computer readable program code that when executed by the processing circuitry 1703 causes the processing circuitry to perform operations according to embodiments disclosed herein. According to other embodiments, processing circuitry 1703 may be defined to include memory so that separate memory circuitry is not required. Wireless device UE may also include an interface (such as a user interface) coupled with processing circuitry 1703, and/or wireless device UE may be incorporated in a vehicle.

As discussed herein, operations of wireless device UE may be performed by processing circuitry 1703 and/or transceiver circuitry 1701. For example, processing circuitry 1703 may control transceiver circuitry 1701 to transmit communications through transceiver circuitry 1701 over a radio interface to a radio access network node (also referred to as a base station) and/or to receive communications through transceiver circuitry 1701 from a RAN node over a radio interface. Moreover, modules may be stored in memory circuitry 1705, and these modules may provide instructions so that when instructions of a module are executed by processing circuitry 1703, processing circuitry 1703 performs respective operations.

### FIG. 18

FIG. 18 is a block diagram illustrating elements of a radio access network RAN node 1800 (also referred to as a network node, base station, eNodeB/eNB, gNodeB/gNB, etc.) of a Radio Access Network (RAN) configured to provide cellular communication according to embodiments of inventive concepts. (RAN node 1800 may be provided, for example, as discussed below with respect to network node QQ160 of FIG. 27.) As shown, the RAN node may include transceiver circuitry 1801 (also referred to as a transceiver, e.g., corresponding to portions of interface QQ190 of FIG. 27) including a transmitter and a receiver configured to provide uplink and downlink radio communications with mobile terminals. The RAN node may include network interface circuitry 1807 (also referred to as a network interface, e.g., corresponding to portions of interface QQ190 of FIG. 27) configured to provide communications with other nodes (e.g., with other base stations) of the RAN and/or core network CN. The network node may also include a processing circuitry 1803 (also referred to as a processor, e.g., corresponding to processing circuitry QQ170) coupled to the transceiver circuitry, and a memory circuitry 1805 (also referred to as memory, e.g., corresponding to device readable medium QQ180 of FIG. 27) coupled to the processing circuitry. The memory circuitry 1805 may include computer readable program code that when executed by the processing circuitry 1803 causes the processing circuitry to perform operations according to embodiments disclosed herein. According to other embodiments, processing circuitry 1803 may be defined to include memory so that a separate memory circuitry is not required.

As discussed herein, operations of the RAN node may be performed by processing circuitry 1803, network interface 1807, and/or transceiver 1801. For example, processing circuitry 1803 may control transceiver 1801 to transmit downlink communications through transceiver 1801 over a radio interface to one or more mobile terminals UEs and/or to receive uplink communications through transceiver 1801 from one or more mobile terminals UEs over a radio interface. Similarly, processing circuitry 1803 may control network interface 1807 to transmit communications through network interface 707 to one or more other network nodes and/or to receive communications through network interface from one or more other network nodes. Moreover, modules may be stored in memory 1805, and these modules may provide instructions so that when instructions of a module are executed by processing circuitry 1803, processing circuitry 1803 performs respective operations.

According to some other embodiments, a network node may be implemented as a core network CN node without a transceiver. In such embodiments, transmission to a wireless device UE may be initiated by the network node so that transmission to the wireless device is provided through a network node including a transceiver (e.g., through a base station or RAN node). According to embodiments where the network node is a RAN node including a transceiver, initiating transmission may include transmitting through the transceiver.

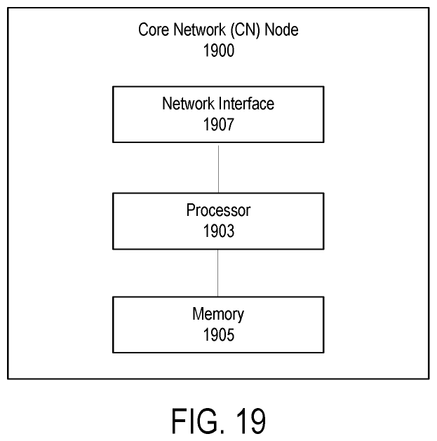

FIG. 19

FIG. 19 is a block diagram illustrating elements of a core network CN node 1900 (e.g., an SMF node, an AMF node, etc.) of a communication network configured to provide cellular communication according to embodiments of inventive concepts. As shown, the CN node 1900 may include network interface circuitry 1907 (also referred to as a network interface) configured to provide communications with other nodes of the core network and/or the radio access network RAN. The CN node 1900 may also include a processing circuitry 1903 (also referred to as a processor) coupled to the network interface circuitry, and memory circuitry 1905 (also referred to as memory) coupled to the processing circuitry. The memory circuitry 1905 may include computer readable program code that when executed by the processing circuitry 1903 causes the processing circuitry to perform operations according to embodiments disclosed herein. According to other embodiments, processing circuitry 1903 may be defined to include memory so that a separate memory circuitry is not required.

As discussed herein, operations of the CN node 1900 may be performed by processing circuitry 1903 and/or network interface circuitry 1907. For example, processing circuitry 1903 may control network interface circuitry 1907 to transmit communications through network interface circuitry 1907 to one or more other network nodes and/or to receive communications through network interface circuitry from one or more other network nodes. Moreover, modules may be stored in memory 1905, and these modules may provide instructions so that when instructions of a module are executed by processing circuitry 1903, processing circuitry 1903 performs respective operations.

As discussed herein, operations of the UE 1700 may be performed by processing circuitry 1703 and/or transceiver 1701. For example, processing circuitry 1703 may control transceiver 1701 to transmit communications via antenna 1707 to one or more network nodes and/or to receive communications via antenna 1707 from one or more network nodes. Moreover, modules may be stored in memory 1705, and these modules may provide instructions so that when instructions of a module are executed by processing circuitry 1703, processing circuitry 1703 performs respective operations.

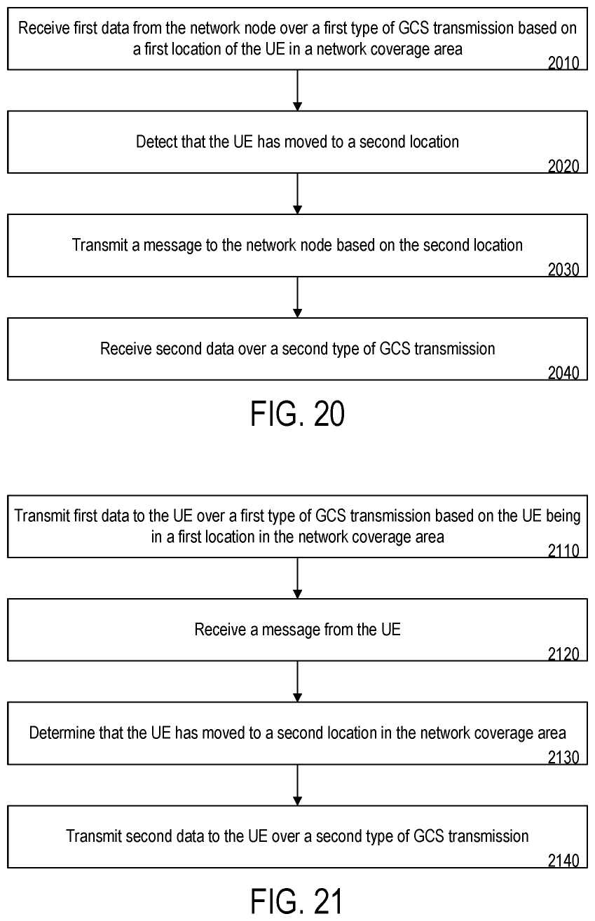

Operations of UE 1700 will now be discussed with reference to FIG. 20 according to some embodiments of inventive concepts. For example, modules (also referred to as units) may be stored in memory 1705 of FIG. 17, and these modules may provide instructions so that when the instructions of a module are executed by processor 1703, processor 1703 performs respective operations of the flow charts of FIG. 20.

### FIG. 20

FIG. 20 depicts a flow chart illustrating an example of a process for operating a UE 1700 that is communicating with a network node (e.g., RAN node 1800 or CN node 1900) of a GCS network.

At block 2010, processor 1703 receives, via transceiver 1701, first data from the network node over a first type of GCS transmission based on a first location of the UE in a network coverage area. In some embodiments, the network coverage area is a multimedia broadcast multicast services over a single frequency network (“MBSFN”). In additional or alternative embodiments, the network node is a GCS application server. In additional or alternative embodiments, the first data can include a first service area identifier.

At block 2020, processor 1703 detects that the UE has moved to a second location. In some embodiments, processor 1703 detects that the UE has moved between an inner area and an outer area of the network coverage area. In additional or alternative embodiments, prior to detecting that the UE has moved to the second location, processor 1703 can receive an indication of an inner service area identifier, SAI, corresponding to the inner area of the network coverage area and an indication of an outer SAI corresponding to the outer area of the network coverage area. The processor 1703 can detect that the UE has moved to the second location by receiving a first SAI with the first data and receiving additional data including a second SAI and then determining that the second SAI is different than the first SAI. In additional or alternative embodiments, processor 1703 can determine whether the UE is in the inner area or the outer area of the network coverage area based on the second SAI. In additional or alternative embodiments, processor 1703 detects that the UE has moved to the second location based on detecting a change in radio conditions. In some examples, the radio condition can change based on a passing car, increased interference, or changes in weather conditions. In additional or alternative embodiments, processor 1703 detects that the UE has moved to the second location based on detecting a physical location of the UE.

At block 2030, processor 1703 transmits, via transceiver 1701, a message to the network node based on the second location. In some embodiments, processor 1703 transmits the message in response to detecting that the UE has moved to the second location. In additional or alternative embodiments, processor 1703 notifies the network node as to whether the UE is in the inner area or the outer area of the network coverage area and requests the second type of GCS transmission. In additional or alternative embodiments, processor 1703 notifies the network node of the SAI associated with the location of the UE. In additional or alternative embodiments, the processor 1703 notifies the network node about changes in radio conditions. In additional or alternative embodiments, processor 1703 notifies the network node about a physical location of the UE.

At block 2040, processor 1703 receives, via transceiver 1701, second data over a second type of GCS transmission. In some embodiments, processor 1703 receives the data in response to transmitting the message.

In some embodiments, the first location is an outer area of the MBSFN coverage area and the second location is an inner area of the MBSFN coverage area. Additionally, the first type of GCS transmission is unicast and MBMS and the second type of GCS transmission is only MBMS. In additional or alternative embodiments, the first location is an inner area of the MBSFN coverage area and the second location is an outer area of the MBSFN coverage area. Additionally, the first type of GCS transmission is only MBMS, and the second type of GCS transmission is MBMS and unicast. In additional or alternative embodiments, the first location is an inner area or an outer area of the first MBSFN coverage area and the second location is an inner area or an outer area of a second MBSFN coverage area. Additionally, the first type of GCS transmission comprises first MBMS, and the second type of GCS transmission comprises second MBMS. In additional or alternative embodiments, the first location is outside of the MBSFN coverage area and the second location is an outer area the MBSFN coverage area. Additionally, the first type of GCS transmission is only unicast, and the second type of GCS transmission is unicast and MBMS. In additional or alternative embodiments, the first location is an outer area of the MBSFN coverage area and the second location is outside the MBSFN coverage area. Additionally, the first type of GCS transmission is unicast and MBMS, and the second type of GCS transmission is only unicast.

Various operations of FIG. 20 may be optional with respect to some embodiments.

### FIG. 21

Operations of RAN node 1800 will now be discussed with reference to FIG. 21 according to some embodiments of inventive concepts. For example, modules (also referred to as units) may be stored in memory 1805 of FIG. 18, and these modules may provide instructions so that when the instructions of a module are executed by processor 1803, processor 1803 performs respective operations of the flow charts of FIG. 21.

At block 2110, processor 1803 transmits, via transceiver 1801 and/or network interface 1807, first data to the UE over a first type of GCS transmission based on the UE being in a first location in a network coverage area. In some embodiments, the network coverage area is a multimedia broadcast multicast services over a single frequency network (“MBSFN”). In additional or alternative embodiments, the network node is a GCS application server. In additional or alternative embodiments, the first data can include a first service area identifier. In additional or alternative embodiments, processor 1803 can transmit an indication of an inner service area identifier, SAI, corresponding to the inner area of the network coverage area and an indication of an outer SAI corresponding to the outer area of the network coverage area.

At block 2120, processor 1803 receives, via transceiver 1801 and/or network interface 1807, a message from the UE. In some embodiments, the message indicates whether the UE is in an inner area or an outer area of the network coverage area and requests the second type of GCS transmission. In additional or alternative embodiments, the message indicates a SAI received by the UE.

At block 2130, processor 1803 determines that the UE has moved to a second location in the network coverage area. In some embodiments, processor 1803 determines whether the UE has moved into an inner area or an outer area of the network coverage area based on a SAI received in the message. In additional or alternative embodiments, processor 1803 determines that the UE has moved physical location and/or that a radio condition for the UE has changed based on the message.

At block 2140, processor 1803 transmits, via transceiver 1801 and/or network interface 1807, second data to the UE over a second type of GCS transmission. In some embodiments, processor 1803 transmits the second data in response to determining that the UE has moved to the second location. In some embodiments, processor 1803 decides to transmit the second data to the UE over the second type of GCS transmission based on determining whether the UE has moved into the inner area or the outer area of the network coverage area.

In some embodiments, the first location is an outer area of the MBSFN coverage area and the second location is an inner area of the MBSFN coverage area. Additionally, the first type of GCS transmission is unicast and MBMS and the second type of GCS transmission is only MBMS. In additional or alternative embodiments, the first location is an inner area of the MBSFN coverage area and the second location is an outer area of the MBSFN coverage area. Additionally, the first type of GCS transmission is only MBMS, and the second type of GCS transmission is MBMS and unicast. In additional or alternative embodiments, the first location is an inner area or an outer area of the first MBSFN coverage area and the second location is an inner area or an outer area of a second MBSFN coverage area. Additionally, the first type of GCS transmission comprises first MBMS, and the second type of GCS transmission comprises second MBMS. In additional or alternative embodiments, the first location is outside of the MBSFN coverage area and the second location is an outer area the MBSFN coverage area. Additionally, the first type of GCS transmission is only unicast, and the second type of GCS transmission is unicast and MBMS. In additional or alternative embodiments, the first location is an outer area of the MBSFN coverage area and the second location is outside the MBSFN coverage area. Additionally, the first type of GCS transmission is unicast and MBMS, and the second type of GCS transmission is only unicast.

Various operations of FIG. 21 may be optional with respect to some embodiments.

Explanations for abbreviations from the above disclosure are provided below.

### Abbreviation Explanation

AS Application Server
BM-SC Broadcast Multicast-Service Centre
CEC Critical Embms Controller
MC Mission Critical
MCData Mission Critical Data
MCPTT Mission critical Push To Talk
MO Managed Object
MBSFN Multicast-Broadcast Single Frequency Network
SFN Single Frequency Network
SA Service Announcement
SAI Service Area Identifier

### Some Embodiments

Some embodiments described above may be summarized in the following manner:
1. A method of operating a wireless device, UE, that is communicating with a network node of a group communication services, GCS, network, the method comprising:
   receiving (2010) first data from the network node over a first type of GCS transmission based on a first location of the UE relative to a network coverage area;
   detecting (2020) that the UE has moved to a second location;
   responsive to detecting that the UE has moved to the second location, transmitting (2030) a message to the network node based on the second location; and
   responsive to transmitting the message to the network node, receiving (2040) second data over a second type of GCS transmission that is different than the first type of GCS transmission.
2. The method of embodiment 1, wherein the network coverage area is a multimedia broadcast multicast services, MBMS, over a Single Frequency Network, MBSFN, coverage area,
   wherein the first location is an outer area of the MBSFN coverage area, and the second location is an inner area of the MBSFN coverage area, and
   wherein the first type of GCS transmission is unicast and MBMS, and the second type of GCS transmission is only MBMS.
3. The method of embodiment 1, wherein the network coverage area is a multimedia broadcast multicast services, MBMS, over a Single Frequency Network, MBSFN, coverage area,
   wherein the first location is an inner area of the MBSFN coverage area and the second location is an outer area of the MBSFN coverage area, and
   wherein the first type of GCS transmission is only MBMS, and the second type of GCS transmission is MBMS and unicast.
4. The method of embodiment 1, wherein the network coverage area is a first multimedia broadcast multicast services, MBMS, over a Single Frequency Network, MBSFN, coverage area,
   wherein the first location is an inner area or an outer area of the first MBSFN coverage area and the second location is an inner area or an outer area of a second MBSFN coverage area, and
   wherein the first type of GCS transmission comprises first MBMS, and the second type of GCS transmission comprises second MBMS.
5. The method of embodiment 1, wherein the network coverage area is a multimedia broadcast multicast services, MBMS, over a Single Frequency Network, MBSFN, coverage area,
   wherein the first location is outside of the MBSFN coverage area, and the second location is an outer area the MBSFN coverage area, and
   wherein the first type of GCS transmission is only unicast, and the second type of GCS transmission is unicast and MBMS.
6. The method of embodiment 1, wherein the network coverage area is a multimedia broadcast multicast services, MBMS, over a Single Frequency Network, MBSFN, coverage area,
   wherein the first location is an outer area of the MBSFN coverage area, and the second location is outside the MBSFN coverage area, and
   wherein the first type of GCS transmission is unicast and MBMS, and the second type of GCS transmission is only unicast.
7. The method of any of embodiments 1-6, wherein detecting that the UE has moved to the second location comprises detecting that the UE has moved between an inner area and an outer area of the network coverage area, and
   wherein transmitting the message to the network node comprises notifying the network node as to whether the UE is in the inner area or the outer area of the network coverage area and requesting the second type of GCS transmission.
8. The method of embodiment 7, further comprising receiving, prior to detecting that the UE has moved to the second location, an indication of an inner service area identifier, SAI, corresponding to the inner area of the network coverage area and an indication of an outer SAI corresponding to the outer area of the network coverage area,
   wherein receiving the first data comprises receiving a first SAI, and
   wherein detecting that the UE has moved to the second location further comprises:
      receiving additional data comprising a second SAI; and
      determining that the UE has moved to the second location based on the second SAI being different than the first SAI,
   the method further comprising determining whether the UE is in the inner area or the outer area of the network coverage area based on the second SAI.
9. The method of an of embodiments 1-6, wherein detecting that the UE has moved to the second location comprises detecting a change in radio conditions, and
   wherein transmitting the message to the network node comprises notifying the network node of an indication of the change in radio conditions.
10. The method of any of embodiments 1-6, wherein detecting that the UE has moved to the second location comprises detecting that the UE has changed physical location, and
   wherein transmitting the message to the network node comprises notifying the network node of an indication of the physical location of the UE.
11. The method of embodiment 10, further comprising receiving, prior to detecting that the UE has moved to the second location, an indication of an inner service area identifier, SAI, corresponding to the inner area of the network coverage area and an indication of an outer SAI corresponding to the outer area of the network coverage area,
   wherein receiving the first data comprises receiving a first SAI, and
   wherein detecting that the UE has moved to the second location further comprises:
      receiving additional data comprising a second SAI; and
      determining that the UE has moved to the second location based on the second SAI being different than the first SAI, and
   wherein the message to the network node comprises the second SAI.
12. The method of any of embodiments 1-11, wherein the network node is a GCS application server, GCS AS.
13. A method of operating a network node that is communicating with a wireless device, UE, of a group communication services, GCS, network, the method comprising:
   transmitting (2110) first data to the UE over a first type of GCS transmission based on the UE being in a first location in the network coverage area;
   receiving (2120) a message from the UE;
   determining (2130), based on the message, that the UE has moved to a second location in the network coverage area; and
   responsive to determining that the UE has moved to the second location in the network coverage area, transmitting (2140) second data to the UE over a second type of GCS transmission that is different than the first type of GCS transmission.
14. The method of embodiment 13, wherein the network coverage area is a multimedia broadcast multicast services, MBMS, over a Single Frequency Network, MBSFN, coverage area,
   wherein the first location is an outer area of the MBSFN coverage area, and the second location is an inner area of the MBSFN coverage area, and
   wherein the first type of GCS transmission is unicast and MBMS, and the second type of GCS transmission is only MBMS.
15. The method of embodiment 13, wherein the network coverage area is a multimedia broadcast multicast services, MBMS, over a Single Frequency Network, MBSFN, coverage area,
   wherein the first location is an inner area of the MBSFN coverage area and the second location is an outer area of the MBSFN coverage area, and
   wherein the first type of GCS transmission is only MBMS, and the second type of GCS transmission is MBMS and unicast.
16. The method of embodiment 13, wherein the network coverage area is a first multimedia broadcast multicast services, MBMS, over a Single Frequency Network, MBSFN, coverage area,
   wherein the first location is an inner area or an outer area of the first MBSFN coverage area and the second location is an inner area or an outer area of a second MBSFN coverage area, and
   wherein the first type of GCS transmission comprises first MBMS, and the second type of GCS transmission comprises second MBMS.
17. The method of embodiment 13, wherein the network coverage area is a multimedia broadcast multicast services, MBMS, over a Single Frequency Network, MBSFN, coverage area,
   wherein the first location is outside of the MBSFN coverage area, and the second location is an outer area the MBSFN coverage area, and
   wherein the first type of GCS transmission is only unicast, and the second type of GCS transmission is unicast and MBMS.
18. The method of embodiment 13, wherein the network coverage area is a multimedia broadcast multicast services, MBMS, over a Single Frequency Network, MBSFN, coverage area,
   wherein the first location is an outer area of the MBSFN coverage area, and the second location is outside the MBSFN coverage area, and
   wherein the first type of GCS transmission is unicast and MBMS, and the second type of GCS transmission is only unicast.
19. The method of any of embodiments 14-18, further comprising transmitting, prior to receiving the message from the UE, an indication of an inner service area identifier, SAI, corresponding to the inner area of the network coverage area and an indication of an outer SAI corresponding to the outer area of the network coverage area.
20. The method of any of embodiments 14-18, wherein the message from the UE indicates whether the UE is in an inner area or an outer area of the network coverage area and requests the second type of GCS transmission.
21. The method of any of embodiments 14-18, wherein the message comprises an indication of a service are identifier, SAI, received by the UE, and
   wherein determining that the UE has moved to a second location in the network coverage area comprises determining whether the UE has moved into an inner area or an outer area of the network coverage area based on the SAI.
22. The method of embodiment 21, wherein determining whether the UE has moved into the inner area or the outer area of the network coverage area based on the SAI comprises determining that the UE has moved physical location and/or a radio condition for the UE has changed.
23. The method of embodiment 21, wherein transmitting second data to the UE over a second type of GCS transmission comprises determining to transmit the second data to the UE over the second type of GCS transmission based on the determining whether the UE has moved into the inner area or the outer area of the network coverage area.
24. The method of any of embodiments 13-23, wherein the network node is a GCS application server, GCS AS.
25. A wireless device, UE, (1700) that is operable to communicate with a network node of a group communication services, GCS, network, the UE comprising:
   a processor (1703); and
   memory (1705) coupled to the processor, the memory having instructions stored therein that are executable by the processor for causing the processor to:
      receive (2010) first data from the network node over a first type of GCS transmission based on a first location of the UE in a network coverage area;
      detect (2020) that the UE has moved to a second location;
      responsive to detecting that the UE has moved to the second location, transmit (2030) a message to the network node based on the second location; and
      responsive to transmitting the message to the network node, receive (2040) second data over a second type of GCS transmission that is different than the first type of GCS transmission.
26. The UE of embodiment 25, wherein the instructions are further executable by the processor for causing the processor to perform the operations of embodiments 2-12.
27. A network node (1800) that is operable to communicate with a wireless device, UE, of a group communication services, GCS, network, the network node comprising:
   a processor (1803); and
   memory (1805) coupled to the processor, the memory having instructions stored therein that are executable by the processor for causing the processor to:
   transmit (2110) first data to the UE over a first type of GCS transmission based on the UE being in a first location in the network coverage area;
   receive (2120) a message from the UE;
   determine (2130), based on the message, that the UE has moved to a second location in the network coverage area; and
   responsive to determining that the UE has moved to the second location in the network coverage area, transmit (2140) second data to the UE over a second type of GCS transmission that is different than the first type of GCS transmission.
28. The network node of embodiment 27, wherein the instructions are further executable by the processor for causing the processor to perform the operations of embodiments 14-24.
29. A non-transitory computer-readable medium having instructions stored therein that are executable by a wireless device, UE, (1700) that is communicating with a network node (1800) of a group communication services, GCS, network, to cause the UE to:
   receive (2010) first data from the network node over a first type of GCS transmission based on a first location of the UE in a network coverage area;
   detect (2020) that the UE has moved to a second location;
   responsive to detecting that the UE has moved to the second location, transmit (2030) a message to the network node based on the second location; and
   responsive to transmitting the message to the network node, receive (2040) second data over a second type of GCS transmission that is different than the first type of GCS transmission.
30. The non-transitory computer-readable medium of embodiment 25, wherein the instructions are further executable by the UE for causing the UE to perform the operations of embodiments 2-12.
31. A non-transitory computer-readable medium having instructions stored therein that are executable by a network node (1800) that is communicating with a wireless device, UE, (1700) of a group communication services, GCS, network, to cause the network node to:
   transmit (2110) first data to the UE over a first type of GCS transmission based on the UE being in a first location in the network coverage area;
   receive (2120) a message from the UE;
   determine (2130), based on the message, that the UE has moved to a second location in the network coverage area; and
   responsive to determining that the UE has moved to the second location in the network coverage area, transmit (2140) second data to the UE over a second type of GCS transmission that is different than the first type of GCS transmission.
32. The non-transitory computer-readable medium of embodiment 27, wherein the instructions are further executable by the network node for causing the network node to perform the operations of embodiments 14-24.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof. Furthermore, as used herein, the common abbreviation “e.g.”, which derives from the Latin phrase “exempli gratia,” may be used to introduce or specify a general example or examples of a previously mentioned item and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method of operating a wireless device, UE, that is communicating with a network node of a group communication services, GCS, network, the method comprising:
receiving first data from the network node over a first type of GCS transmission based on a first location of the UE relative to a network coverage area;
detecting that the UE has moved to a second location;
responsive to detecting that the UE has moved to the second location, transmitting a message to the network node based on the second location; and
responsive to transmitting the message to the network node, receiving second data over a second type of GCS transmission that is different than the first type of GCS transmission.

2-6. (canceled)

7. The method of claim 1, wherein detecting that the UE has moved to the second location comprises detecting that the UE has moved between an inner area and an outer area of the network coverage area, and
wherein transmitting the message to the network node comprises notifying the network node as to whether the UE is in the inner area or the outer area of the network coverage area and requesting the second type of GCS transmission.

8. The method of claim 7, further comprising receiving, prior to detecting that the UE has moved to the second location, an indication of an inner service area identifier, SAI, corresponding to the inner area of the network coverage area and an indication of an outer SAI corresponding to the outer area of the network coverage area,
wherein receiving the first data comprises receiving a first SAI, and
wherein detecting that the UE has moved to the second location further comprises:
receiving additional data comprising a second SAI; and
determining that the UE has moved to the second location based on the second SAI being different than the first SAI,
the method further comprising determining whether the UE is in the inner area or the outer area of the network coverage area based on the second SAI.

9-12. (canceled)

13. A method of operating a network node that is communicating with a wireless device, UE, of a group communication services, GCS, network, the method comprising:
transmitting first data to the UE over a first type of GCS transmission based on the UE being in a first location in the network coverage area;
receiving a message from the UE;
determining, based on the message, that the UE has moved to a second location in the network coverage area; and
responsive to determining that the UE has moved to the second location in the network coverage area, transmitting second data to the UE over a second type of GCS transmission that is different than the first type of GCS transmission.

14. The method of claim 13, wherein the network coverage area is a multimedia broadcast multicast services, MBMS, over a Single Frequency Network, MBSFN, coverage area,
wherein the first location is an outer area of the MBSFN coverage area, and the second location is an inner area of the MBSFN coverage area, and
wherein the first type of GCS transmission is unicast and MBMS, and the second type of GCS transmission is only MBMS.

15-18. (canceled)

19. The method of claim 14, further comprising transmitting, prior to receiving the message from the UE, an indication of an inner service area identifier, SAI, corresponding to the inner area of the network coverage area and an indication of an outer SAI corresponding to the outer area of the network coverage area.

20. The method of claim 14, wherein the message from the UE indicates whether the UE is in an inner area or an outer area of the network coverage area and requests the second type of GCS transmission.

21. The method of claim 14, wherein the message comprises an indication of a service are identifier, SAI, received by the UE, and
wherein determining that the UE has moved to a second location in the network coverage area comprises determining whether the UE has moved into an inner area or an outer area of the network coverage area based on the SAI.

22. (canceled)

23. The method of claim 21, wherein transmitting second data to the UE over a second type of GCS transmission comprises determining to transmit the second data to the UE over the second type of GCS transmission based on the determining whether the UE has moved into the inner area or the outer area of the network coverage area.

24. (canceled)

25. A wireless device, UE, that is operable to communicate with a network node of a group communication services, GCS, network, the UE comprising:
a processor; and
memory coupled to the processor, the memory having instructions stored therein that are executable by the processor for causing the processor to:
receive first data from the network node over a first type of GCS transmission based on a first location of the UE in a network coverage area;
detect that the UE has moved to a second location;
responsive to detecting that the UE has moved to the second location, transmit a message to the network node based on the second location; and
responsive to transmitting the message to the network node, receive second data over a second type of GCS transmission that is different than the first type of GCS transmission.

26. The UE of claim 25, wherein the instructions are further executable by the processor for causing the processor to perform the operations of claim 2.

27. A network node that is operable to communicate with a wireless device, UE, of a group communication services, GCS, network, the network node comprising:
a processor; and
memory coupled to the processor, the memory having instructions stored therein that are executable by the processor for causing the processor to:
transmit first data to the UE over a first type of GCS transmission based on the UE being in a first location in the network coverage area;
receive a message from the UE;
determine, based on the message, that the UE has moved to a second location in the network coverage area; and
responsive to determining that the UE has moved to the second location in the network coverage area, transmit second data to the UE over a second type of GCS transmission that is different than the first type of GCS transmission.

28. The network node of claim 27, wherein the instructions are further executable by the processor for causing the processor to perform the operations of claim 14.

29. A non-transitory computer-readable medium having instructions stored therein that are executable by a wireless device, UE, that is communicating with a network node of a group communication services, GCS, network, to cause the UE to:
receive first data from the network node over a first type of GCS transmission based on a first location of the UE in a network coverage area;
detect that the UE has moved to a second location;
responsive to detecting that the UE has moved to the second location, transmit a message to the network node based on the second location; and
responsive to transmitting the message to the network node, receive second data over a second type of GCS transmission that is different than the first type of GCS transmission.

30. The non-transitory computer-readable medium of claim 25, wherein the instructions are further executable by the UE for causing the UE to perform the operations of claim 2.

31. A non-transitory computer-readable medium having instructions stored therein that are executable by a network node that is communicating with a wireless device, UE, of a group communication services, GCS, network, to cause the network node to:
transmit first data to the UE over a first type of GCS transmission based on the UE being in a first location in the network coverage area;
receive a message from the UE;
determine, based on the message, that the UE has moved to a second location in the network coverage area; and
responsive to determining that the UE has moved to the second location in the network coverage area, transmit second data to the UE over a second type of GCS transmission that is different than the first type of GCS transmission.

32. The non-transitory computer-readable medium of claim 27, wherein the instructions are further executable by the network node for causing the network node to perform the operations of claim 14.
